(19) United States
(12) Patent Application Publication
(10) Pub. No.: US 2023/0314383 A1
(43) Pub. Date: Oct. 5, 2023

(54) PORTABLE RAILROAD SPIKE INSPECTION SYSTEM BASED ON ACOUSTIC SIGNALS

(71) Applicant: University of South Carolina, Columbia, SC (US)

(72) Inventors: Yu Qian, Irmo, SC (US); Jun Liu, Raleigh, NC (US)

(73) Assignee: University of South Carolina, Columbia, SC (US)

(21) Appl. No.: 18/187,036

(22) Filed: Mar. 21, 2023

Related U.S. Application Data
(60) Provisional application No. 63/322,277, filed on Mar. 22, 2022.

(51) Int. Cl. G01N 29/44; G01N 29/04

(52) U.S. Cl. CPC G01N 29/046; G01N 29/4436; G01N 29/4445; G01N 2291/0234; G01N 2291/2626

(57) ABSTRACT

Described herein are systems, methods and devices for gathering sound emission data from railway spikes in order to determine if a spike is undamaged, damaged, or broken via initiating sound waves in the spike and analyzing same to determine the structural integrity of the spike being tested.

### TECHNICAL FIELD

The subject matter disclosed herein is generally directed to systems, methods and devices for gathering sound emission data from railway spikes in order to determine if a spike is undamaged, damaged, or broken via initiating sound waves in the spike and analyzing same to determine the structural integrity of the spike being tested.

### BACKGROUND

The United States have, approximately, 140,000 miles of railway composed of rails secured to timber substrates via spikes driven through tie plates and into the timber substrates to maintain the rail in place. Observations of railways commonly report broken spikes, including cut spikes, screw spikes, and driven spikes that were used to restrict both tie plates and rails. Since the cracks are typically underneath the spike head, it is very difficult to distinguish the broken spikes without a physical check, which raises great challenges in track health evaluation and operation safety. Several recent derailments in Canada and the United States are attributed to a large number of broken spikes or screws within a certain section of track. Current spike evaluation approaches need specialized sensors or excitation equipment and are expensive, not portable, and hard to operate.

There have been efforts for providing non-destructive spike testing approaches using ultrasonic, laser, or air-coupled wave sensors to detect cracks in railroad spikes. However, due to the energy loss through wave propagation and decay, the effective waves that can be collected from those sensors are limited. The detection accuracy is limited and the equipment cost is expensive. Accordingly, it is an object of the present disclosure to provide a low-cost, accurate, and portable system for detecting damaged railway spikes as well as determining if spikes are undamaged.

Citation or identification of any document in this application is not an admission that such a document is available as prior art to the present disclosure.

### SUMMARY

The above objectives are accomplished according to the present disclosure by providing, in one aspect, a railroad spike inspection system. The system may include a mobile platform containing at least one hitting mechanism for performing at least one strike to at least one railroad spike, the at least one strike generates at least one audible sound signature and at least one vibration characteristic length for the at least one railroad spike and at least one audio detection system captures the at least one audible sound signature and at least one vibration characteristic length, the at least one audible sound signature and at least one vibration characteristic generate at least one pitch for the at least one railroad spike and a tone of the at least one pitch indicates the spike is broken, wherein the system may be further configured to be non-destructive to the at least one spike being tested; and the system may operate on at least one railroad track and provide results in real-time as the system traverses the at least one railroad track. Further, the at least one hitting mechanism may comprise at least one hammer. Still yet, the audio detection system may comprise at least one microphone. Yet again, the system may include at least one AI based signal processing unit. Still again, the at least one AI based signal processing unit may analyze the at least one audible sound signature and at least one vibration characteristic length for the at least one railroad spike. Furthermore, the at least one AI based signal processing unit may filter noise from the at least one audible sound signature and at least one vibration characteristic length for the at least one railroad spike. Moreover, the at least one AI based signal processing unit may establish multiple auditory thresholds for determining whether a spike is broken and applies at least one auditory threshold to a track segment being inspected by selecting an auditory threshold established for physical conditions that most closely resemble physical conditions present for the track segment. Yet again, the at least one railroad spike is at least partially embedded in at least one railroad tie. Even further, the at least one audio detection system may not contact the at least one railroad spike. Example AIs may include GOOGLE, AMAZON, MICROSOFT, H2O.ai, IBM, GOOGLE BRAIN TEAM, DATAROBOT, WIPRO HOLMES, SALESFORCE, and/or INFOSYS.

In a further aspect, a method for inspecting railroad spikes is disclosed. The method may include moving a non-destructive railroad spike inspection system along at least one railroad track, striking at least one railroad spike positioned along the railroad track with at least one hitting mechanism, generating via the at least one strike at least one audible sound signature and at least one vibration characteristic length for the at least one railroad spike and at least one audio detection system captures the at least one audible sound signature and at least one vibration characteristic length, wherein the at least one audible sound signature and at least one vibration characteristic generate at least one pitch for the at least one railroad spike and a tone of the at least one pitch indicates the spike is broken, configuring the system to be non-destructive to the at least one spike being tested; operating the system on at least one railroad track; and providing results in real-time as the system traverses the at least one railroad track. Further, the at least one hitting mechanism may comprise at least one hammer. Still yet, the audio detection system may comprise at least one microphone. Further again, the method may include a processor and at least one AI based signal processing unit. Yet still, the method may process the at least one AI based signal processing unit, the at least one audible sound signature and at least one vibration characteristic length for the at least one railroad spike. Further again, the method may filter, via the at least one AI based signal processing unit, noise from the at least one audible sound signature and at least one vibration characteristic length for the at least one railroad spike. Again further, the method may establish, via the at least one AI based signal processing unit, multiple auditory thresholds for determining whether a spike is broken and applying at least one auditory threshold to a track segment being inspected by selecting an auditory threshold established for physical conditions that most closely resemble physical conditions present for the track segment. Still further again, the method may analyze the at least one railroad spike while at least partially embedded in at least one railroad tie. Again still, employing the method may not result in the at least one audio detection system contacting the at least one railroad spike.

These and other aspects, objects, features, and advantages of the example embodiments will become apparent to those having ordinary skill in the art upon consideration of the following detailed description of example embodiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

An understanding of the features and advantages of the present disclosure will be obtained by reference to the following detailed description that sets forth illustrative embodiments, in which the principles of the disclosure may be utilized, and the accompanying drawings of which:

FIG. 1 shows damages railroad spikes that may be found along a typical section of railroad.

FIG. 2 shows example of railroad spikes along with a xylophone.

FIG. 3 shows a testing scenario with damaged and whole railroad spikes driven into wooden timbers.

FIG. 4 shows a further testing scenario where spikes are hit from varying heights to determine the effect of different energy levels

FIG. 5 shows one embodiment of a testing set-up for the current disclosure.

FIG. 6 shows graphical analysis of sound signals and frequency domains obtained from the testing scenarios.

FIG. 7 shows data consistency for intrinsic acoustic modes.

FIG. 8 shows intrinsic acoustic modes do not change with different hitting conditions.

FIG. 9 shows an illustration using a piano keyboard to show the differing tonalities reflected via “bad” and “good” railroad spikes.

FIG. 10 shows a graphical analysis of a frequency shift in a defective spike.

FIG. 11 shows a table providing frequency shift data for defective spikes.

FIG. 12 shows multiple mode testing can be used to confirm spike condition accuracy.

FIG. 13 shows one embodiment of a testing device of the current disclosure.

FIG. 14 shows a smartphone receiving sound analysis data.

FIG. 15 shows photos of field observed broken spikes.

FIG. 16 shows an experimental setup to demonstrate different height and constraining conditions on an impacted spike.

FIG. 17 shows examples of candidate microphones.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/-10% or less, +/-5% or less, +/-1% or less, and +/-0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g. mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### KITS

Any of the analysis methods and testing devices described herein can be presented as a combination kit. As used herein, the terms “combination kit” or “kit of parts” refers to the methods, devices, and systems and any additional components that are used to package, sell, market, deliver, and/or administer the combination of elements or a single element, such as the testing method and testing devices, contained therein. Such additional components include, but are not limited to, packaging, blister packages, and the like. When one or more of the testing methods and/or testing devices described herein or a combination thereof contained in the kit are provided simultaneously, the combination kit can contain the testing system, device, and/or method in a single package or in separate packages. When the methods, systems, and devices described herein or a combination thereof and/or kit components are not provided simultaneously, the combination kit can contain each method, system and/or device in separate combinations. The separate kit components can be contained in a single package or in separate packages within the kit.

In some embodiments, the combination kit also includes instructions printed on or otherwise contained in a tangible medium of expression. The instructions can provide information regarding the content of the kit, safety information regarding the method, system and/or device, information regarding usage, and/or recommended testing regimen(s) for the systems, methods, and/or devices contained therein. In some embodiments, the instructions can provide directions and protocols for administering the systems, methods, and/or devices described herein.

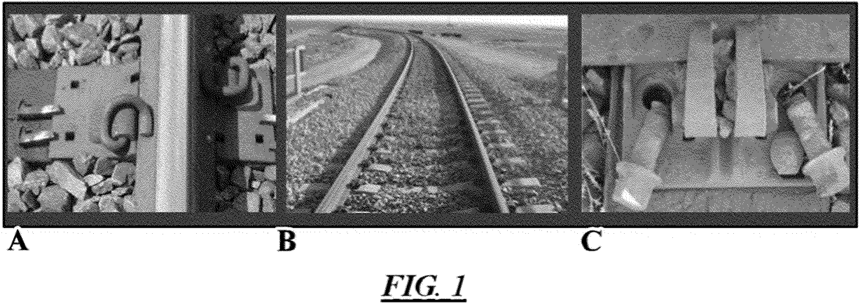

FIG. 1 shows at A, broken railroad ties, at B a span of railroad track, and at C an image of broken bolts adjacent a train rail. This portable systems, methods, and devices described herein can identify broken and cracked railroad spikes according to the acoustic signals. By hitting the spikes with a hammer or other objects, the spikes will vibrate and produce sound. The acoustic signal is analyzed to identify the main frequencies and patterns for intact spikes, broken spikes, and partially crack spikes. We have found the main frequencies and patterns of the acoustic signals from intact spikes, broken spikes, and partially crack spikes are quite different and distinguishable. Thus, we can use the acoustic signals from the spikes to identify intact spikes, broken spikes, and partially cracked spikes by hitting the spikes and collect and analyze the acoustic signals.

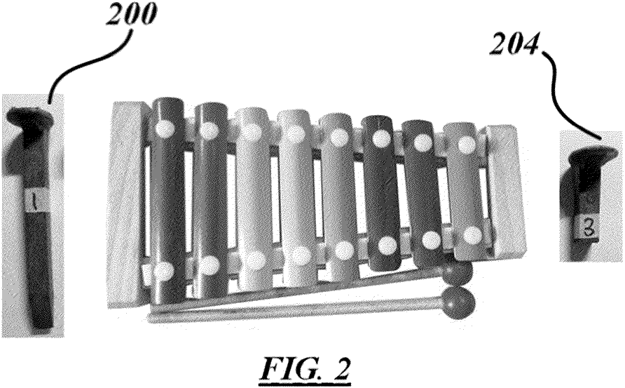

FIG. 2 shows a whole railroad spike 200 and damaged spike 204 on opposing sides of a xylophone to represent the different sounds whole spike 200 and damaged spike 204 will made when struck. Analysis of these sounds will help a user determine if the spike being examined is whole or damaged.

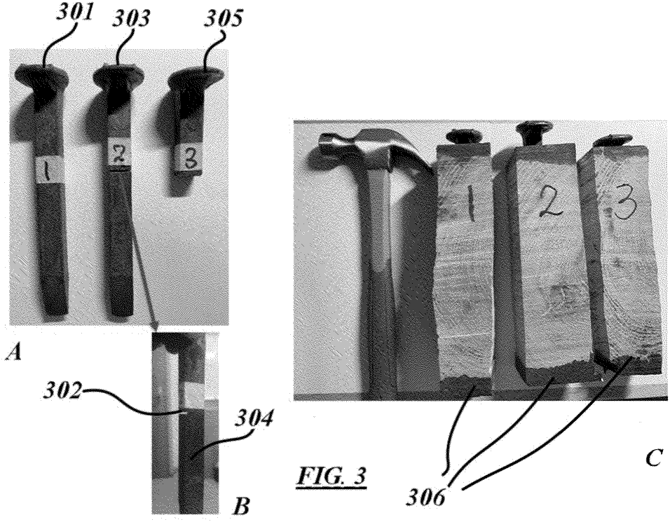

FIG. 3 shows one possible testing method for the current disclosure wherein A shows railroad spikes in different conditions undamaged 301, damaged 303 and broken 305, such as whole, damaged and/or broken, B shows a spike with an intentionally formed defect 302, such as a cut or incision, made into the spike body 304, and C shows the various condition spikes driven into timbers 306 to emulate how the spikes will appear when placed in a railroad setting. One can hit the spike head with a hammer or anything else that is portable as long as this strike will generate sound. One may use a microphone to record the sound emanating from the spike once struck. The difference in the sound from different spikes can help distinguish intact spikes, broken spikes, and partially cracked spikes.

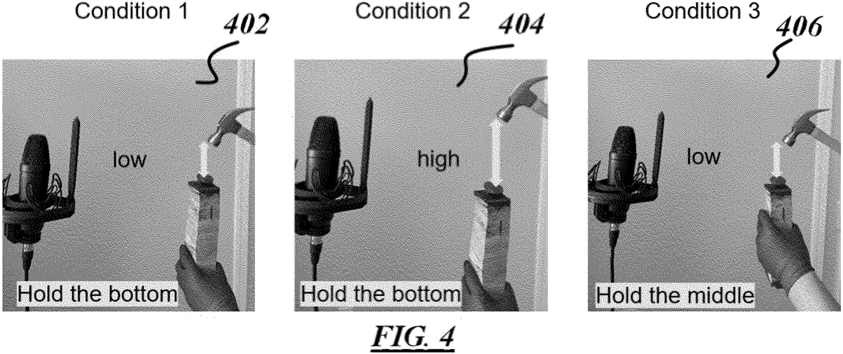

One aspect of this disclosure that improves over existing spike testing systems is the lack of requiring specific, repeatable, reproducible interaction with spikes of varying condition. Indeed, as FIG. 4 shows, testing may be conducted at varying strike levels and with the spike and its containment environment secured at different heights along the spike body, specifically mimicking the different conditions spikes may be found in during actual railway testing based on being driven into wooden timbers of varying condition, density, etc. Here, Condition 1 402 shows a small or low velocity strike on a spike held at the bottom of the securing environment, Condition 2 404 shows a high velocity strike with the spike secured at its bottom, Condition 3 406 shows a low velocity strike with the spike secured in the middle of the containment environment.

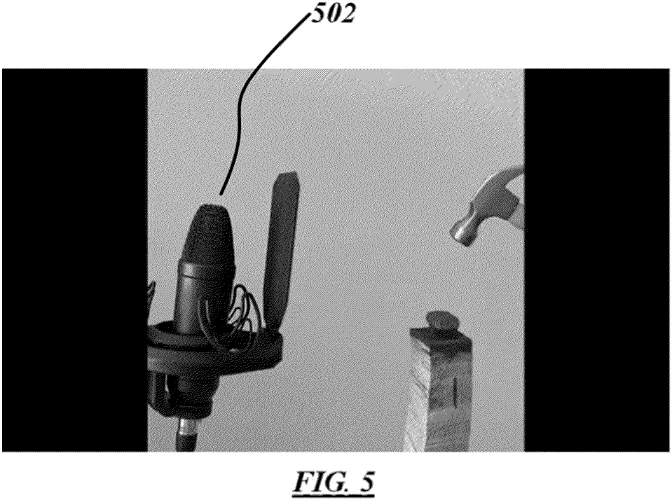

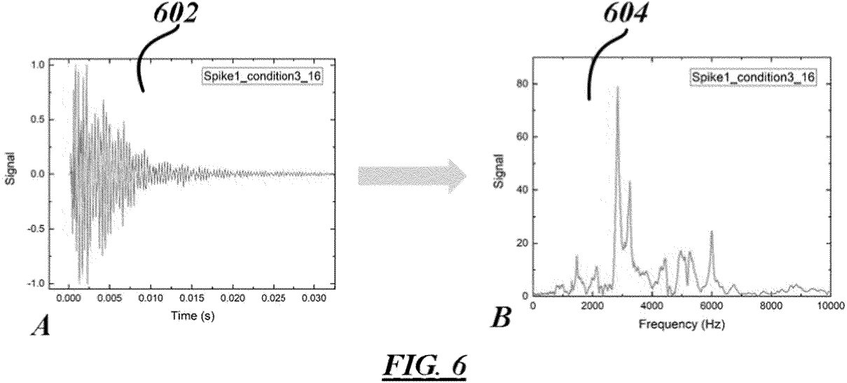

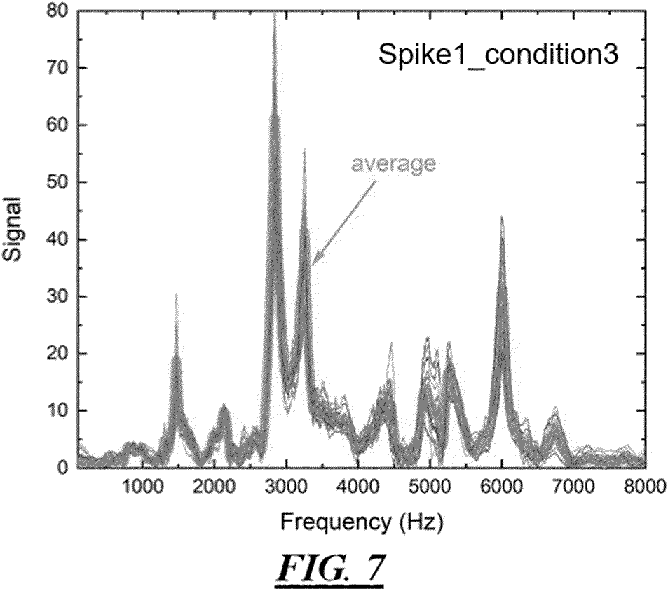

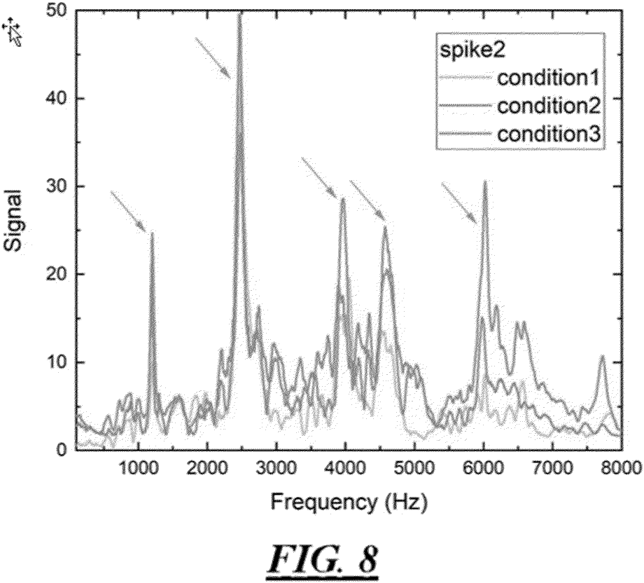

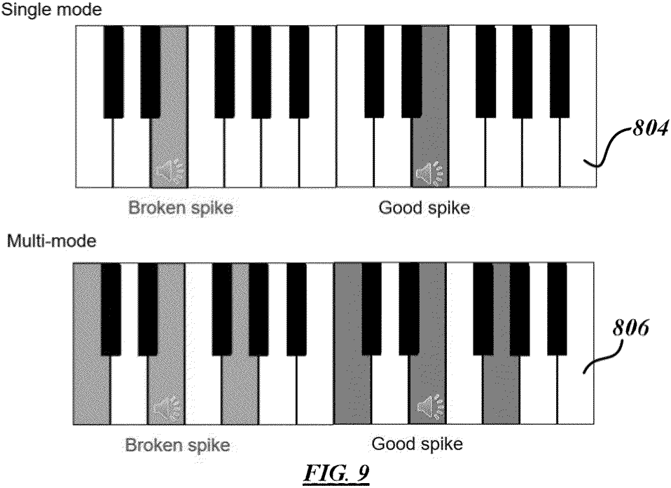

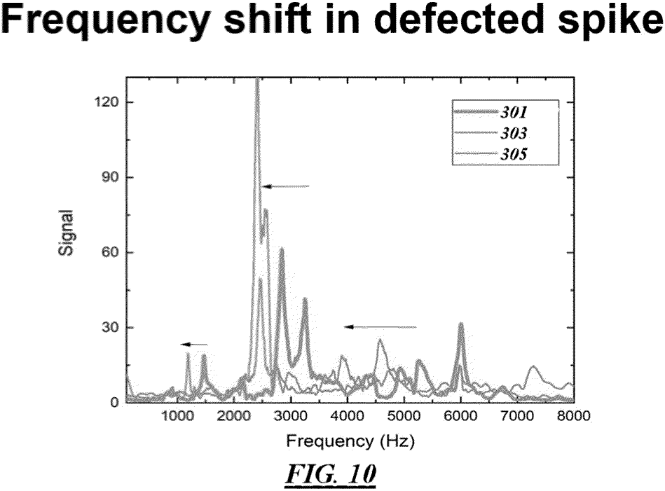

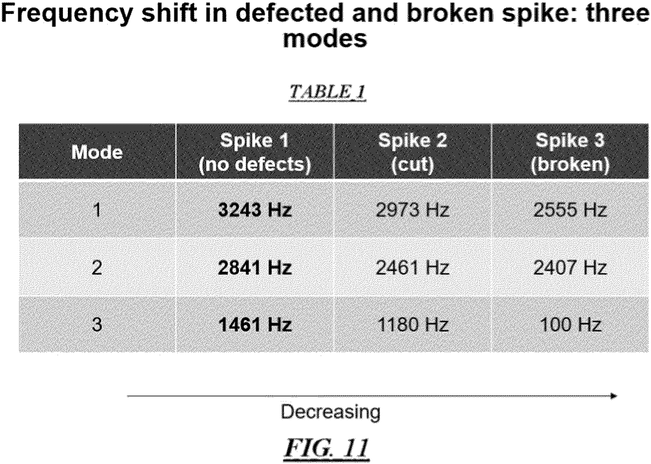

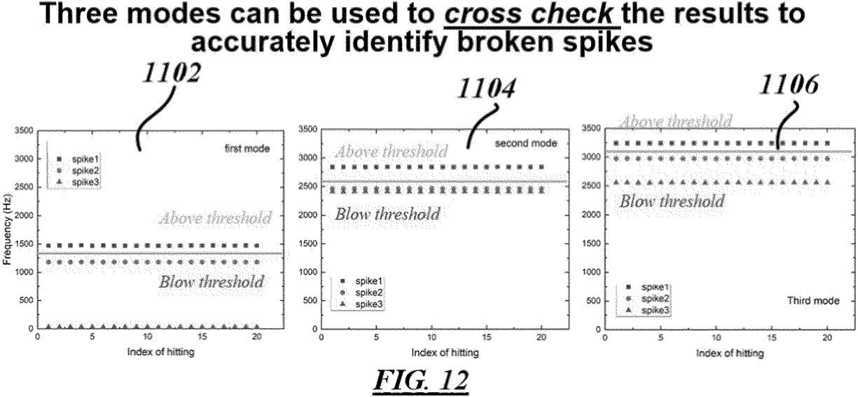

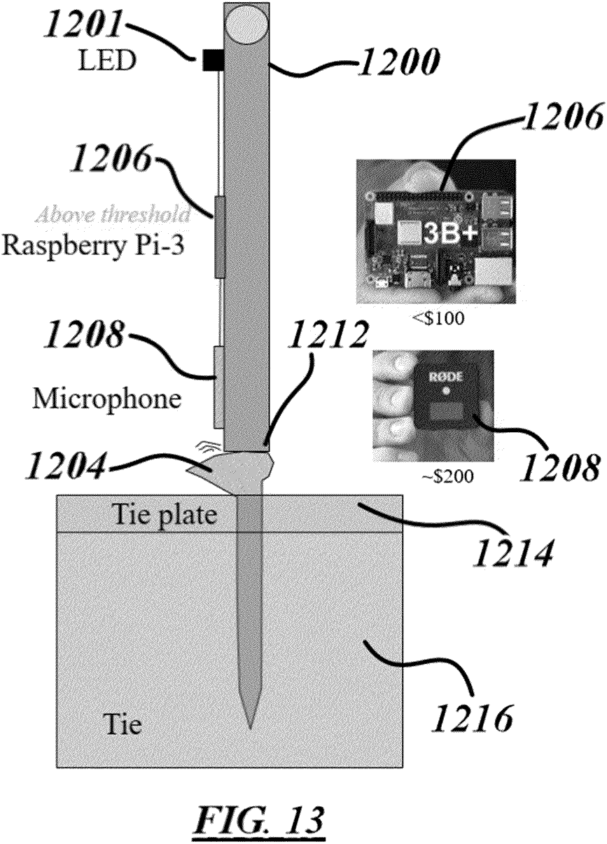

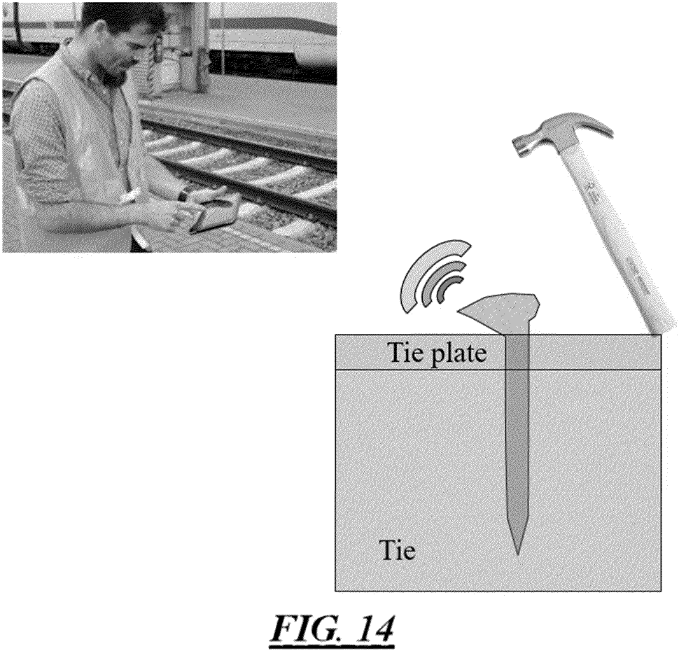

As FIG. 5 shows, the system of the current disclosure simply needs an ordinary hammer or a dropping ball, or anything else capable of striking a spike to elicit a sound signal. One can simply record the acoustic signals (the sound) with an ordinary microphone 502 or even smartphones. With the developed signal processing codes of the system, we can identify the signal main frequency in different modes and patterns. FIG. 6 shows at A, the recorded sound signal 602 may be transformed into a frequency domain 604 shown at B. By comparing the main frequencies and patterns of the acoustic signals, the current disclosure we can distinguish intact spikes, broken spikes, and partially broken spikes. This approach does not rely on specialized sensors, but a simple hammer and microphone are enough with the current disclosures developed analyzing code. Thus, our proposed system is significantly cheaper, practical, and easy to operate. Indeed, FIG. 7 shows that even though striking the embedded spikes may provide different excitations for the various spikes, the intrinsic acoustic modes are consistent. To wit, just like pressing the same key in a piano with varying force still produces the same note. FIG. 8 shows that spikes experiencing Condition 1 402, Condition 2 404, and Condition 3 406 of FIG. 4 have intrinsic acoustic modes that do not change based on different strike conditions. While separate/different/multiple modes are present, this is simply due to the spikes vibrating in different modes. Indeed, these multiple modes each produce a certain sound and multiple modes provide more sound references for determining the integrity condition of spikes. FIG. 9 shows that while single mode 802 can determine a broken spike as compared to an undamaged spike via a single sound, multi-mode 804 provides even more sounds that can further help define spike integrity and further differentiate a damaged spike from an undamaged spike. FIG. 10 shows undamaged spike 301, damaged spike 303 and broken spike 305 that damaged spikes, have different frequencies. Indeed, damaged spike 303 and broken spike 305 show a frequency shift indicating damage to the spike and broken spike 305 shows a consistently smaller frequency over its intrinsic modes as compared to undamaged spike 301 and damaged spike 303. FIG. 11 shows Table 1, the frequency shift detected in damaged and broken spikes. As FIG. 10 shows, undamaged spike 301 (Spike 1) has higher frequencies than both damaged spike 303 (Spike 2) and broken spike 305 (Spike 3). FIG. 12 shows that First Mode 1102, Second Mode 1104, and Third Mode 1106 may be used to cross check results to confirm damaged or undamaged spikes. Further, in one embodiment, see FIG. 13, the entire system may be integrated into a wand 1200 that includes an LED 1201 for shining light and/or locating spike 1204, a processor 1206 such as a Raspberry Pi-3, a microphone 1208, such as a RODE Microphone to gather sounds from spike 1204 and a wand body 1210 to perform spike excitation by striking spike 1204 at distal end 1212 of wand body 1210. Wand 1200 allows for strike excitation, sound gathering, acoustic analyzing, and spike damage results provided in one simple device while spike 1204 passes through tie plate 1214 and is embedded in tie 1216. FIG. 14 shows that the system may be further modified via incorporation of a computer application that sends data from wand 1200 directly to a smartphone or other device.

The current disclosure provides a cost-effective and portable, instant evaluation system that is able to identify broken spikes in the field. The proposed system features with Hit and Know capability, and will integrate low-cost hammer, microphone, and signal processing unit onto a portable platform. The current disclosure will significantly improve the efficiency and accuracy in spike inspection, enhance safety of railroad track, and benefit all the stakeholders in industry, and railroad administration and legislation.

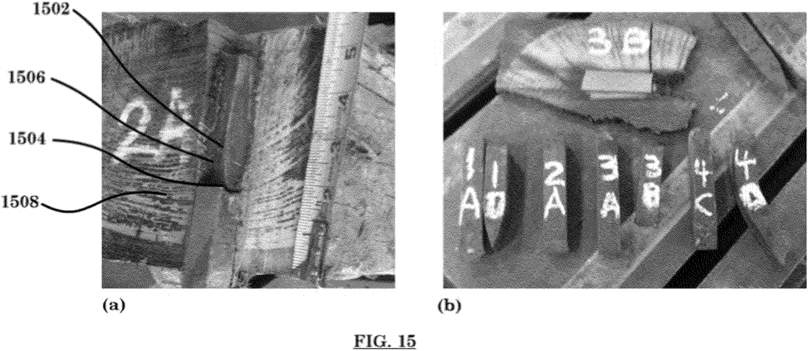

Although a considerable number of new types of elastic fasteners and concrete ties have been introduced recently, cut spikes (referred as spike hereafter) together with tie plates and timber ties are the dominant track components in North America freight railroads. For centuries, spikes, with marginal changes in terms of their geometry and material, have been consistently providing reliable restrictions to the rails. Spikes have also been used to fix tie plates to the timber or composite ties when elastic fasteners are used to restrain the rail. With the increasing axle load and operation speed, spikes are subjected to more demanding loading conditions, especially in those territories where tracks have high curvature and are subjected to high axle loads. It is reported that broken spikes were observed frequently, including cut spikes, screw spikes, and driven spikes that are used to restrict both tie plates and rails (Gao et al. 2018). Since the cracks are typically underneath the spike head, it is very difficult to distinguish the broken spikes without physical inspection of the spike body, which raises great challenges in track health evaluation and operation safety. Several recent derailments in Canada and the United States are attributed to a large number of broken spikes or screws within a certain section of track (TSBC 2012, FRA 2016, Kerchof 2017). FIG. 15 shows photos of observed broken spikes. FIG. 15 at (a) shows a broken spike 1502 where break 1504 is below the rail spike head, not shown, and not discernible by visual inspection as break 1504 is “submerged” within railroad spike body 1506 and surrounded by railroad tie body 1508 and would not be visible without destructive testing to railroad tie body 1508. FIG. 15 at (b) shows several railroad spikes where various breaks have occurred below railroad spike head within the bodies of the various spikes.

Traditional track inspection methods can hardly identify any broken spikes other than manually pulling each spike out which is not practical. To understand the underlying failure mechanisms and to develop preventive strategies for the spike failures, previous research has investigated the force distribution, force transmission, and damage development mechanisms at track, tie, and individual spike levels by numerical simulations (Dersch et al. 2019 and 2020; Yu and Liu, 2019). Recently TTCI has started to examine the spikes with instrumented strain gages to sense the load (Gao et al., 2020). FRA and TTCI have completed a preliminary investigation of ultrasonic techniques to identify cracked or broken spikes in track (Gao et al., 2021). The ultrasonic piezoelectric transducer has shown some degree of success in detecting the broken spikes. The sensitivity of the frequencies and diameter on the rate of success was studied on different spikes. The report also highlighted the challenges in the use of contact piezoelectric transducers. Moreover, it is also challenging to use non-contact transducers to inspect the broken spikes in the field due to the cost and rapid signal decay rate. Considering the enormous number of spikes in service, the drastic consequences of unrecognized broken spikes, and the challenge to quantify the service condition of the spikes, it is urgent to develop a practical yet economical solution to facilitate efficient and accurate inspection tailored for spikes in the track.

One challenge with using ultrasonic or laser types of excitations or transducers is the low signal/noise ratio due to the limited amount of energy penetrated into or absorbed by the spikes and rapid decay of the effective signals at the interface. Considering the nature of the spikes in terms of their shape and materials, we propose to develop a cost-effective and portable, non-destructive Hit and Know evaluation system by using hammer to excite the spikes and use the audible sound signals to identify broken spikes in the field. The theoretical foundation of the proposed system is very mature, basically the relationship between the sound signature or tone and the vibration characteristic length of the objects which is basis for all the musical instruments. The Hit and Know system basically aims to identify broken spikes based on the pitch of the audible sound when the spikes are subject to a direct hit. The proposed system consists of four key modules: Module I: Hammer (calibrated hitting system for spike excitation); Module II: Ear (microphone to collect the audible sound/signals); Module III: Brain (AI based signal processing unit), and Module IV: System Integration. The details of each individual module are presented below:

### Module I: Hammer (Calibrated Hitting System for Spike Excitation)

This module is primarily used to identify and quantify the most suitable and practical hammer and dropping height that need to be used for exciting the spikes in the working environments. Due to the consistency of the spikes in terms of materials and shape, their sensitive excitation resonant frequency range should be relatively stable for the same types of spikes. However, the varying confinement levels from the ties may alter the vibration pattern of the spikes and the track. Note the geometric configurations of the three main types of spikes, cut spike, drive spike, and screw spike also varies. Thus, the sensitive measure in terms of excitation energy level could be different for the different types of spikes. The research team proposes to perform a large number of laboratory experiments to obtain the audible sound wave patterns for different spikes under different confining levels with different levels of impact energy. This way, a relative narrow range of the excitation level can be identified which would help to narrow down the options of hammer weight and hammer dropping height considering the portability. A calibrated hammer would also help to narrow down the range of the signal variation from the spikes, which will in turn to ease the complexity of the signal processing work later.

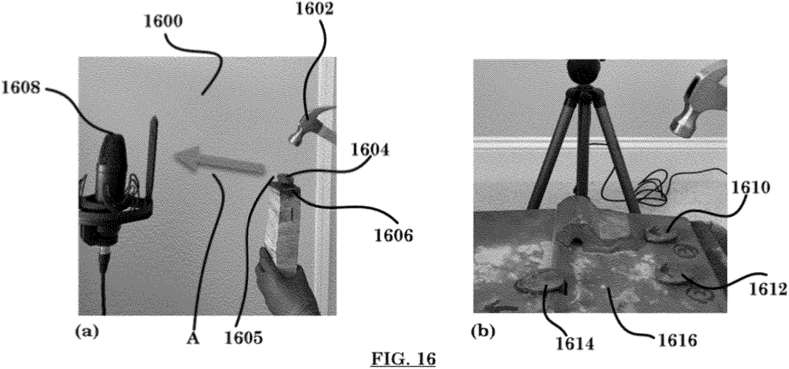

FIG. 16 at (a) shows one testing system 1600 wherein a hitting mechanism 1602, which may comprise at least one hammer, strikes embedded spike 1604. Herein, “embedded” refers to a spike that is at least partially driven into a railroad tie or other substrate. The spike may be driven until underside 1605 of railroad spike head 1604 contacts or is substantially approximate railroad tie surface 1606. Striking embedded spike 1602 generates both acoustic and vibration signals, represented by arrow A, which may be captured by a detection system 1608, which in one embodiment may comprise a microphone. FIG. 16 at (b) shows various spikes 1610, 1612, and 1614 embedded into substrate 1616, which may comprise a tie plate as encountered on railway surfaces.

### Module II Ear (Suitable Microphone to Collect the Audible Sound/Signals)

According to one of the FRA provided reports, the piezoelectric types of transducers that was used by TTCI for broken spike detection was of contact type, which required a coupling agent to provide signal transmission (or penetration) into the spike. They have provided considerable meaningful results in the laboratory, yet still unreliable in many cases for the rough and non-planar spike heads yielding false alarms. The transducer head needed to be moved around to find the best point of signal penetration. This type of non-destructive inspection using the piezoelectric dry-coupled transducer is time-consuming and unreliable even in controlled laboratory environments, unsuited for field inspection.

From a different perspective, giving enough excitations to the spikes (e.g., using a hammer to hit the spikes), audible sounds will be produced due to the vibration of the spikes and other track components. The audible sound waves will also decay but may survive much longer and are easier collected by simple transducers (e.g., microphones) than the ultrasonic or acoustic waves in the air. Recent FRA report “Inspection of Concrete Ties Using Sonic/ultrasonic Impact Velocity and Echo Measurements” (2018) has proved the feasibility and reliability of using readily available microphones to collect sound waves efficiently.

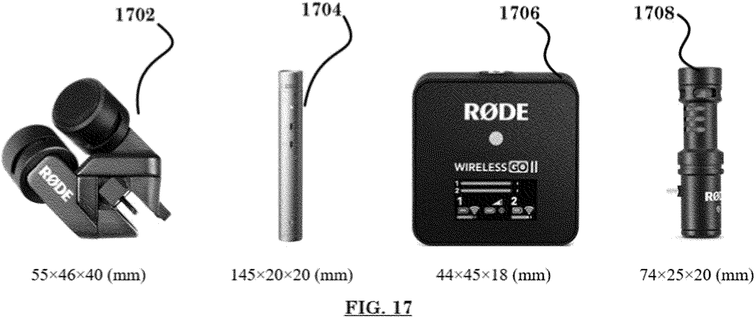

Given the recent development of portable microphones for High-definition (HD) audio collection, the research team proposes to explore the popular readily available HD microphones first and expand to high-end microphones that can also capture ultrasonic signals with active noise cancelling functions. FIG. 17 shows some candidate microphones 1702, 1704, 1706, and 1708 the proposal team have tried or evaluated in the preliminary study. FIG. 17 shows exemplary sizes of the microphones that may be used with the current disclosure. Those candidate cameras priced between $100-$300 with effective frequency measurement of 20 Hz-20 kHz. Based on the preliminary results showed on Module III, those microphones are sufficient to distinguish the broken spikes from the intact spikes in laboratory conditions. Another intriguing aspect of the current disclosure is that the microphones do not need to contact the embedded spike in order to obtain signals from the spike. This resolves issues with needing to position signal collecting equipment at various positions and orientations with respect to the spike being tested.

Module III: Brain (AI based signal processing unit, which may be a processor containing the AI program and software): Signal processing includes filtering from noise and analyze the effective sound wave patterns. The specific challenges in signal processing are twofold: 1) weak signal and 2) noisy signal. Based on the research team’s extensive experience in sound waves, we propose to solve the signal processing challenges through signal modulation and deconvolution. This approach is to provide higher signal-to-noise ratio (SNR) and higher spatial resolution. The collected sound wave is transferred into frequency domain to identify potential patterns and modes as shown in FIG. 6. Note different conditions means different hammer drop heights, in other words, different excitation energy levels.

After hitting the spike multiple times, the repeatability of the sound wave spectrum can be analyzed. FIG. 7 shows good repeatability of the same spike from the preliminary study, confirming the vibration pattern will not change when the restriction and spike remains the same. FIG. 8 shows the different hammer dropping heights will change the response sound magnitude but the frequency is the same. Again, this is the same idea as the piano should produce the same note when the same key is pressed regardless of how hard the key is pressed. As long as the spike or the retrain conditions remain the same, the vibration pattern of the spike should be the same. For different spike conditions, the analyzed spectrum can be compared to identify any differences to distinguish broken or anomalous spikes from the intact spikes. FIGS. 10, 11, and 12 present preliminary results obtained from the laboratory test. It is easy to see the main frequencies of the partially broken spike and broken spike reduce from the frequency of the intact spike, especially the difference between the intact spike and the broken spike is very obvious. Again, this observation well aligns with our experience with guitar. A broken string is easily identified by ears.

The challenge of this module is to identify the most suitable auditory threshold to distinguish the broken spikes from the intact spikes. Unfortunately, a single threshold value will not meet the expectations of the field practices. The vibration of the spikes is dictated by both the spikes themselves and other track component that may be in contact with the spike to retain same on the track. One threshold value established based on a certain track segment may cause a false alarm in a different track segment. Considering the variation of the track components and their health conditions and service conditions, a better option would be developing an active learning AI module to find the suitable threshold accordingly to training dataset based on the actual trial test dataset from each segment of the track. Thus, the AI may be able to select from multiple auditory thresholds based on the real-world conditions present for the spikes used/embedded in a particular segment of track. For example, if sixteen auditory thresholds are available, the AI will select the auditory threshold that most closely resembles the physical attributes of the track segment being tested, such as spikes used, substrate material, track age, etc.

Module IV: System Integration: Upon the completion of the previous moduli, the research team will develop and demonstrate a complete system that can automatically detect the broken from a selected track segment in the field. Upon future support from FRA, it is also possible to expand the application into different track segments.

Overall, the key technology elements in the proposed NDE system have been successfully developed in our prior efforts for other related engineering applications. The proposed research innovation will start with a Technology Readiness Levels (TRL) 4-5 according to the FRA BAA solicitation.

### Development Framework

The proposed Hit and Know spike inspection system will be developed by leveraging vast R&D experience of the research team on railroad track, wave analysis, sensor tuning, and artificial intelligence development. The proposed innovation is based on commercial-off-the shelf (COT) hammer and microphone, mature signal processing technology, and wave analysis, and reasonable computing power in order to develop a system that is easy to operate and friendly to interpret. Our industrial partner, Norfolk Southern has already agreed to provide all necessary track components and track access during the developing and testing stages. The proposed work is expected to be completed within a period of 24 months.

Overall, the current disclosure provides a non-destructive, real time spike inspection system that will enhance probabilities for determining broken and/or damaged spikes in the field coupled with track-oriented dataset AI Training for high accuracy to provide a low-cost but highly effective system for determining and monitoring railroad spike health. The system may be contain on a mobile platform such as a specialized railcar, ATV, or other suitable means for moving along a railway system.

Various modifications and variations of the described systems, methods, devices, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A railroad spike inspection system comprising:
a mobile platform containing at least one hitting mechanism for performing at least one strike to at least one railroad spike;
wherein the at least one strike generates at least one audible sound signature and at least one vibration characteristic length for the at least one railroad spike and at least one audio detection system captures the at least one audible sound signature and at least one vibration characteristic length;
wherein the at least one audible sound signature and at least one vibration characteristic generate at least one pitch for the at least one railroad spike and a tone of the at least one pitch indicates the spike is broken;
wherein the system is further configured to be non-destructive to the at least one spike being tested; and
the system operates on at least one railroad track and provides results in real-time as the system traverses the at least one railroad track.

2. The system of claim 1, wherein the at least one hitting mechanism comprises at least one hammer.

3. The system of claim 1, wherein the audio detection system comprises at least one microphone.

4. The system of claim 1, further comprising at least one AI based signal processing unit.

5. The system of claim 4, wherein the at least one AI based signal processing unit analyzes the at least one audible sound signature and at least one vibration characteristic length for the at least one railroad spike.

6. The system of claim 5, wherein the at least one AI based signal processing unit filters noise from the at least one audible sound signature and at least one vibration characteristic length for the at least one railroad spike.

7. The system of claim 4, wherein the at least one AI based signal processing unit establishes multiple auditory thresholds for determining whether a spike is broken and applies at least one auditory threshold to a track segment being inspected by selecting an auditory threshold established for physical conditions that most closely resemble physical conditions present for the track segment.

8. The system of claim 1, wherein the at least one railroad spike is at least partially embedded in at least one railroad tie.

9. The system of claim 1, wherein the at least one audio detection system does not contact the at least one railroad spike.

10. A method for inspecting railroad spikes comprising:
moving a non-destructive railroad spike inspection system along at least one railroad track;
striking at least one railroad spike positioned along the railroad track with at least one hitting mechanism;
generating via the at least one strike at least one audible sound signature and at least one vibration characteristic length for the at least one railroad spike and at least one audio detection system captures the at least one audible sound signature and at least one vibration characteristic length;
wherein the at least one audible sound signature and at least one vibration characteristic generate at least one pitch for the at least one railroad spike and a tone of the at least one pitch indicates the spike is broken;
configuring the system to be non-destructive to the at least one spike being tested;
operating the system on at least one railroad track; and
providing results in real-time as the system traverses the at least one railroad track.

11. The method of claim 10, wherein the at least one hitting mechanism comprises at least one hammer.

12. The method of claim 10, wherein the audio detection system comprises at least one microphone.

13. The method of claim 10, further comprising a processor and at least one AI based signal processing unit.

14. The method of claim 13, further comprising processing, via the at least one AI based signal processing unit, the at least one audible sound signature and at least one vibration characteristic length for the at least one railroad spike.

15. The method of claim 14, further comprising filtering, via the at least one AI based signal processing unit, noise from the at least one audible sound signature and at least one vibration characteristic length for the at least one railroad spike.

16. The method of claim 13, further comprising establishing, via the at least one AI based signal processing unit, multiple auditory thresholds for determining whether a spike is broken and applying at least one auditory threshold to a track segment being inspected by selecting an auditory threshold established for physical conditions that most closely resemble physical conditions present for the track segment.

17. The method of claim 10, further comprising analyzing the at least one railroad spike while at least partially embedded in at least one railroad tie.

18. The method of claim 10, wherein the at least one audio detection system does not contact the at least one railroad spike.
